(19) United States
(12) Patent Application Publication
(10) Pub. No.: US 2026/0224985 A1
(43) Pub. Date: Aug. 6, 2026

(54) INFORMATION PROCESSING METHOD, AND ELECTRONIC DEVICE AND STORAGE MEDIUM

(71) Applicant: NETEASE (HANGZHOU) NETWORK CO., LTD., Hangzhou, Zhejiang (CN)

(72) Inventor: Yunpeng LI, Hangzhou, Zhejiang (CN)

(73) Assignee: NETEASE (HANGZHOU) NETWORK CO., LTD., Hangzhou, Zhejiang (CN)

(21) Appl. No.: 19/148,048

(22) PCT Filed: Aug. 7, 2023
(86) PCT No.: PCT/CN2023/111571

§ 371 Date: Jul. 15, 2025

(30) Foreign Application Priority Data
Jan. 15, 2023 (CN) 202310116242.6

(51) Int. Cl. A63F 13/533; A63F 13/56; A63F 13/57; A63F 13/58

(52) U.S. Cl. CPC A63F 13/533; A63F 13/56; A63F 13/57; A63F 13/58

(57) ABSTRACT

An information processing method, including: in response to a first virtual object entering a first sensing range of a target second virtual object and being outside a second sensing range of the target second virtual object, displaying an indication control with a first display parameter on a graphical user interface; in response to the first virtual object being within the first sensing range and outside the second sensing range and the target second virtual object moving toward the first virtual object, displaying the indication control with a second display parameter on the graphical user interface; in response to the first virtual object entering the second sensing range, displaying the indication control with a third display parameter on the graphical user interface, and updating the position of the indication control on the graphical user interface according to relative positions of the target second virtual object and the first virtual object.

### CROSS REFERENCE TO RELATED APPLICATIONS

The present disclosure is a U.S. National Stage of International Application No. PCT/CN 2023/111571, filed on Aug. 7, 2023, which claims the priority of the Chinese patent application with an application number of 202310116242.6, filed on Jan. 15, 2023, and titled by “INFORMATION PROCESSING METHOD, AND ELECTRONIC DEVICE AND STORAGE MEDIUM”, the entire contents of both of which are incorporated herein by reference for all purposes.

### TECHNICAL FIELD

The present disclosure relates to the field of computers, and in particular, to an information processing method, an electronic device, and a storage medium.

### BACKGROUND

In some games, the graphical user interface may display the relative position information of the enemy characters that are in a hostile relationship with the player character, and in some games, the distance information between the player character and the enemy character may also be displayed. In order to make the virtual scenes and game characters in the game as close to the real world as possible and improve the player's sense of immersion, the virtual scenes and game characters often contain various attributes and parameters. In order to defeat the enemy characters in the game, the player needs to receive and process a large amount of information.

### SUMMARY

According to an aspect of the present disclosure, an information processing method is provided, where a graphical user interface is displayed through a terminal device, and the graphical user interface includes at least a portion of a virtual scene, and a first virtual object and at least one second virtual object located in the virtual scene, where the method includes: in response to the first virtual object entering a first sensing range of a target second virtual object and being located outside a second sensing range of the target second virtual object, displaying an indication control on the graphical user interface with a first display parameter, and updating a position of the indication control on the graphical user interface according to a relative position between the target second virtual object and the first virtual object, where the target second virtual object is one or more of the at least one second virtual object, and the second sensing range is smaller than the first sensing range; in response to the first virtual object being located within the first sensing range and outside the second sensing range and the target second virtual object moving toward the first virtual object, displaying the indication control on the graphical user interface with a second display parameter, and updating the position of the indication control on the graphical user interface according to the relative position between the target second virtual object and the first virtual object; in response to the first virtual object entering the second sensing range, displaying the indication control on the graphical user interface with a third display parameter, and updating the position of the indication control on the graphical user interface according to the relative position between the target second virtual object and the first virtual object.

According to an aspect of the present disclosure, an electronic device is provided, and the device includes: a processor; and a memory for storing executable instructions of the processor; where the processor is configured to perform the following method by executing the executable instructions:

in response to the first virtual object entering a first sensing range of a target second virtual object and being located outside a second sensing range of the target second virtual object, displaying an indication control on the graphical user interface with a first display parameter, and updating a position of the indication control on the graphical user interface according to a relative position between the target second virtual object and the first virtual object, where the target second virtual object is one or more of the at least one second virtual object, and the second sensing range is smaller than the first sensing range;

in response to the first virtual object being located within the first sensing range and outside the second sensing range and the target second virtual object moving toward the first virtual object, displaying the indication control on the graphical user interface with a second display parameter, and updating the position of the indication control on the graphical user interface according to the relative position between the target second virtual object and the first virtual object; and
in response to the first virtual object entering the second sensing range, displaying the indication control on the graphical user interface with a third display parameter, and updating the position of the indication control on the graphical user interface according to the relative position between the target second virtual object and the first virtual object.

According to an aspect of the present disclosure, a computer-readable storage medium is provided, on which a computer program is stored, and the computer program, when executed by a processor, implements the following method:
in response to the first virtual object entering a first sensing range of a target second virtual object and being located outside a second sensing range of the target second virtual object, displaying an indication control on the graphical user interface with a first display parameter, and updating a position of the indication control on the graphical user interface according to a relative position between the target second virtual object and the first virtual object, where the target second virtual object is one or more of the at least one second virtual object, and the second sensing range is smaller than the first sensing range;
in response to the first virtual object being located within the first sensing range and outside the second sensing range and the target second virtual object moving toward the first virtual object, displaying the indication control on the graphical user interface with a second display parameter, and updating the position of the indication control on the graphical user interface according to the relative position between the target second virtual object and the first virtual object; and
in response to the first virtual object entering the second sensing range, displaying the indication control on the graphical user interface with a third display parameter, and updating the position of the indication control on the graphical user interface according to the relative position between the target second virtual object and the first virtual object.

### BRIEF DESCRIPTION OF THE DRAWINGS

FIG. 1 is a schematic flow chart of an information processing method according to an embodiment of the present disclosure;

FIG. 2 is a schematic diagram of an information processing method according to an embodiment of the present disclosure;

FIG. 3 is another schematic diagram of an information processing method according to an embodiment of the present disclosure;

FIG. 4 is another schematic diagram of an information processing method according to an embodiment of the present disclosure;

FIG. 5 is another schematic diagram of an information processing method according to an embodiment of the present disclosure;

FIG. 6 is another schematic diagram of an information processing method according to an embodiment of the present disclosure;

FIG. 7 is another schematic diagram of an information processing method according to an embodiment of the present disclosure; and

FIG. 8 is a schematic block diagram of an electronic device according to an embodiment of the present disclosure.

### DETAILED DESCRIPTION

In order to enable those skilled in the art to better understand the solutions of the present disclosure, the technical solutions in the present disclosure will be clearly and completely described in the following with reference to the accompanying drawings. It is apparent that the described embodiments are only a part of the embodiments of the present disclosure, and not all of the embodiments. On the basis of the embodiments in the present disclosure, all other embodiments obtained by a person of ordinary skill in the art without creative efforts fall within the scope of protection of the present disclosure.

In the specification, claims, and the above-mentioned drawings of the present disclosure, terms such as “first” and “second” are used to distinguish similar objects, and are not necessarily used to describe a specific order or sequence. It should be understood that data used in this way can be interchanged under appropriate circumstances, so that the embodiments of the present disclosure described herein can be implemented in an order other than those illustrated or described herein. Furthermore, the terms “including”, “having” and any variations thereof are intended to cover non-exclusive inclusions. For example, a process, method, system, product, or device that includes a series of steps or units is not necessarily limited to those clearly listed steps or units, but may include other steps or units that are not clearly listed or inherent to these processes, methods, products, or devices.

It should be noted that the steps shown in the flowcharts of the accompanying drawings can be executed in a computer system such as a set of computer-executable instructions, and although a logical order is shown in the flowcharts, in some cases, the steps shown or described can be executed in an order different from that shown herein.

First, the nouns involved in the present disclosure are introduced:

### (1) Virtual Scene (Game Scene)

A virtual scene is a virtual scene displayed (or provided) when an application runs on a terminal or server. In some embodiments, the virtual scene is a simulated environment of the real world, a semi-simulated and semi-fictional virtual environment, or a purely fictional virtual environment. The virtual scene is any one of a two-dimensional virtual scene, a 2.5-dimensional virtual scene, and a three-dimensional virtual scene. The virtual environment may be a sky, land, ocean, etc., where the land includes environmental elements such as deserts and cities. The virtual scene is a scene for a user to control a virtual object with complete game logic. For example, in a sandbox-style 3D shooting game, the virtual scene is a 3D game world for players to control virtual objects to fight, and example virtual scenes may include: at least one element of mountains, plains, rivers, lakes, oceans, deserts, skies, plants, buildings, and vehicles, etc. For example, for 2D or 2.5D card games, the virtual scene is a scene for displaying the release of cards or displaying virtual objects corresponding to cards, and example virtual scenes may include: an arena, a decisive battlefield, or other “field” elements or other elements that can display the status of card battles. For a 2D or 2.5D multiplayer online tactical competitive game, the virtual scene is a 2D or 2.5D terrain scene for virtual objects to fight, and example virtual scenes may include: canyon-style mountains, routes, rivers, classrooms, desks and chairs, podiums and other elements.

### (2) Game Interface

The game interface refers to the interface corresponding to the application provided or displayed through a graphical user interface, which includes a UI interface for players to interact with and a game screen. In an optional implementation, the UI interface may include game controls (such as skill controls, movement controls, function controls, etc.), indication marks (such as direction indication marks, character indication marks, etc.), information display areas (such as the number of kills, match time, etc.), or game setting controls (such as system settings, stores, gold coins, etc.). In an optional implementation, the game screen is a display screen corresponding to a virtual scene displayed on the terminal device, and the game screen may include virtual objects such as game characters, non-player characters (NPCs), and artificial intelligence (AI) characters that execute game logic in the virtual scene.

### (3) Virtual Object

A virtual object refers to a dynamic object that can be controlled in a virtual scene. In some embodiments, the dynamic object may be a virtual character, a virtual animal, an anime character, etc. The virtual object is a character controlled by the player through an input device, or an AI set in a virtual environment battle through training, or an NPC set in a virtual scene battle. In some embodiments, the virtual object is a virtual character competing in a virtual scene. In some embodiments, the number of virtual objects in the virtual scene battle is preset, or dynamically determined according to the number of clients joining the battle, which is not limited in the embodiments of the present disclosure. In a possible implementation, the user may control the virtual object to move in the virtual scene, for example, control the virtual object to run, jump, crawl, etc., and may also control the virtual object to use skills, virtual props, etc. provided by the application program to fight with other virtual objects.

### (4) Player Character

A player character refers to a virtual object that can be controlled by a player to act in a game environment, also known as a player virtual character or player virtual object. In some electronic games, it may also be referred to as a Shinigami character or a hero character. A player character may be in at least one of different forms such as a virtual person, a virtual animal, a virtual vehicle, etc.

In the long-term research and development process, the applicant of the present disclosure has found that in some games, the graphical user interface may display the relative position information of the enemy characters that are in a hostile relationship with the player character, and in some games, the distance information between the player character and the enemy character may also be displayed. In order to make the virtual scenes and game characters in the game as close to the real world as possible and improve the player's sense of immersion, the virtual scenes and game characters often contain various attributes and parameters. In order to defeat the enemy characters in the game, the player needs to receive and process a large amount of information. However, providing the relative position information or distance information of the enemy characters in the graphical user interface can only enable the players to make simple game decisions such as dodging or attacking, which is not sufficient for the players to have enough information about the enemy characters and the virtual environment in which they are located, so as to make more comprehensive game decisions.

In view of this, the present disclosure provides an information processing method, an electronic device and a storage medium to at least partially solve technical problems such as the single type of information contained in the position prompts of enemy characters in the game, thereby improving the diversity of the types of information contained in the position prompts of enemy characters.

As a possible implementation manner, the control logic codes of the information processing method disclosed herein may be run on a terminal device or a server. The terminal device may be a computer or a mobile phone, and the terminal device may be a local terminal device. When the information processing method disclosed herein runs on a server, the method may be implemented and executed based on a cloud interaction system, where the cloud interaction system includes a server and a client device.

In an optional implementation manner, various cloud applications, such as cloud games, may be run under the cloud interaction system. Taking cloud games as an example, cloud games refer to a game mode based on cloud computing. In the operation mode of cloud games, the operating body of the game program and the main body for presenting the game screen are separated. The storage and operation of the method for controlling the virtual character are completed on the cloud game server, and the client device is used for receiving and sending data as well as presenting the game screen. For example, the client device may be a display device close to the user side with a data transmission function, such as a mobile terminal, a TV, a computer, a handheld computer, etc., while the cloud game server in the cloud is used for information processing. When playing the game, the player operates the client device to send an operation instruction to the cloud game server, the cloud game server runs the game according to the operation instruction, encodes and compresses data like the game screen, and returns it to the client device through the network. Finally, the client device decodes and outputs the game screen.

In an optional implementation manner, the terminal device may be a local terminal device. The local terminal device stores a game program and is used for presenting a game screen. The local terminal device is used to interact with the player via a graphical user interface, that is, the game program is downloaded and installed by an electronic device and run conventionally. The local terminal device may provide the graphical user interface to the player in various ways, for example, the graphical user interface may be rendered and displayed on a display screen of the terminal, or provided to the player through a holographic projection. By way of example, the local terminal device may include a display screen and a processor, the display screen is used to present the graphical user interface, the graphical user interface includes a game screen, and the processor is used to run the game, generate the graphical user interface, and control the display of the graphical user interface on the display screen.

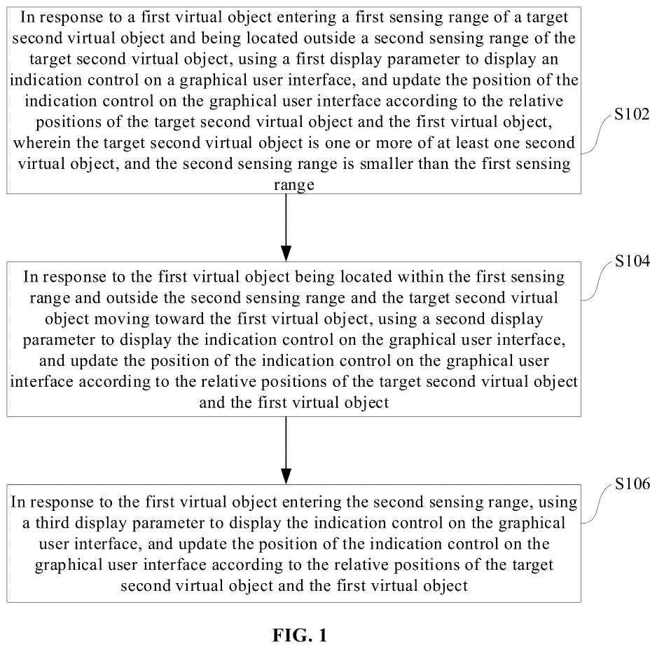

In a possible implementation manner, an embodiment of the present disclosure provides an information processing method, where a graphical user interface is provided through a terminal device, where the terminal may be the local terminal device mentioned above, or may be a client device in the cloud interaction system mentioned above. Referring to FIG. 1, in an information processing method of an embodiment of the present disclosure, a graphical user interface is displayed through a terminal device, where the graphical user interface includes at least part of a virtual scene, and a first virtual object and at least one second virtual object located in the virtual scene. The method may include the following steps.

In step S102, in response to the first virtual object entering a first sensing range of a target second virtual object and being outside a second sensing range of the target second virtual object, an indication control is displayed on the graphical user interface with a first display parameter, and a position of the indication control on the graphical user interface is updated according to a relative position between the target second virtual object and the first virtual object, where the target second virtual object is one or more of the at least one second virtual object, and the second sensing range is smaller than the first sensing range.

In step S104, in response to the first virtual object being located within the first sensing range and outside the second sensing range and the target second virtual object moving toward the first virtual object, the indication control is displayed on the graphical user interface with a second display parameter, and the position of the indication control on the graphical user interface is updated according to the relative position between the target second virtual object and the first virtual object.

In step S106, in response to the first virtual object entering the second sensing range, the indication control is displayed on the graphical user interface with a third display parameter, and the position of the indication control on the graphical user interface is updated according to the relative position between the target second virtual object and the first virtual object.

Through the information processing method in this exemplary embodiment, in response to the first virtual object entering two different sensing ranges of the target second virtual object and the actions taken by the target second virtual object, the indication control related to the position of the target virtual object is displayed with different display parameters. While providing the player with the position information of the target second virtual object, it can also reflect the alert status of the target second virtual object towards the first virtual object, so that the player can make more diverse game decisions. This can at least partially solve the technical problems existing in the relevant technical solutions, such as the types of information contained in the position prompt of the enemy character in the game being single.

Next, the information processing method in this exemplary embodiment will be further described.

In step S102, in response to the first virtual object entering the first sensing range of the target second virtual object and being outside the second sensing range of the target second virtual object, the indication control is displayed on the graphical user interface with the first display parameter, and the position of the indication control on the graphical user interface is updated according to the relative position between the target second virtual object and the first virtual object, the target second virtual object is one or more of the at least one second virtual object, and the second sensing range is smaller than the first sensing range.

The first virtual object is a game character controlled by the player. The player controls the first virtual object to fight with the second virtual object in the game scene. When the trigger condition for displaying the indication control is met, the corresponding second virtual object is the target second virtual object. If there are a plurality of second virtual objects that meet the trigger condition for displaying the indication control, there are also a plurality of indication controls displayed on the graphical user interface.

In order to simulate the real world, the second virtual object, whether it is a game character controlled by other players or a game character controlled by the game AI (such as NPC), has a certain sensing range, including at least a visual sensing range and an auditory sensing range. The visual sensing range is the range that can be observed within the field of view of the second virtual object. Specifically, it may be a cone-shaped range formed by the field of view of the second virtual object. This range changes with the direction and position of the second virtual object, and will also be blocked by obstacles in the game scene (such as walls, mountains and other non-transparent objects). The sensing range may also be the auditory sensing range of the second virtual object, that is, the game character may hear the sound within a certain distance around itself to determine whether there is an enemy. For special game characters, game developers may also endow them with special sensing abilities, so that such game characters have a special sensing range, that is, a sensing range beyond the sensing ranges of general visual sensing and auditory sensing, such as a sixth sense.

In an optional embodiment, the first virtual object entering the first sensing range of the target second virtual object includes: sound emitted by the first virtual object propagating to the first sensing range.

Different from the visual sensing range which is related to the orientation of the game character (i.e. the game character may only observe virtual objects within a certain range in front), the auditory sensing range of the game character may be unrelated to the orientation of the game character, and the game character can hear sounds within a certain distance around it. When the perceptible range (i.e. the propagation range of the sound) of the sound emitted by the first virtual object (the sound emitted by walking, sprinting, crawling forward, hitting objects, attacking, etc.) intersects with the first sensing range of the second virtual object, that is, the sound emitted by the first virtual object is heard by the target second virtual object, it can be regarded as the first virtual object entering the first sensing range of the target virtual object.

In an optional embodiment, when the first virtual object is located within the first sensing range and outside the second sensing range, the target second virtual object is able to sense the existence of the first virtual object but cannot determine the specific location of the first virtual object.

In another optional embodiment, when the first virtual object is located within the second sensing range, the target second virtual object is capable of determining the specific position of the first virtual object.

In this embodiment, in order to distinguish the degree of vigilance of the target second virtual object to the first virtual object in different situations, the sensing range is divided into a first sensing range and a second sensing range. When the first virtual object is within the first sensing range of the target second virtual object, the target second virtual object can perceive the existence of the first virtual object but cannot determine the specific location of the first virtual object; when the first virtual object is within the second sensing range of the target second virtual object, the target second virtual object can determine the specific location of the first virtual object. When the first virtual object is not within the first sensing range of the second virtual object, the second virtual object will not be alert to it, because the first virtual object cannot be perceived by the second virtual object; when the first virtual object enters the first sensing range and is outside the second sensing range of the second virtual object, the first virtual object can be perceived by the second virtual object, in this case, since the second virtual object can only perceive the existence of the first virtual object but is not sure of the specific location of the first virtual object, it cannot immediately pursue and cause damage to the first virtual object, and the degree of alertness to the first virtual object is relatively low; when the first virtual object enters the first sensing range and is outside the second sensing range of the target second virtual object, and the target second virtual object moves toward the first virtual object, the degree of alertness of the target second virtual object to the first virtual object is obviously higher than when it does not move; when the first virtual object enters the second sensing range of the second virtual object (either because the target second virtual object moves toward the first virtual object, or because the first virtual object moves toward the target second virtual object, or because both move toward each other), since the target second virtual object can determine the specific location of the first virtual object in this case, for example, the first virtual object is already within the field of vision of the second virtual object, the degree of alertness to the first virtual object is the highest.

The size, shape and position of the first sensing range and the second sensing range are constantly changing with the relative position of the first virtual object and the target second virtual object, the actions of both parties, and the different environments they are in. What remains unchanged is that the second sensing range is smaller than the first sensing range.

The criterion for the first virtual object to be located in the first sensing range of the second virtual object may be that the first virtual object is located in the visible range of the second virtual object, but the distance is relatively far, and the proportion of the first virtual object in the cross section of the visible range cone is less than a preset value, that is, the distance between the two is too far and the first virtual object cannot be identified by the target second virtual object; or, although the first virtual object is not far from the target second virtual object, the time it stays in the visible range of the target second virtual object is too short, resulting in the second virtual object not having enough time to identify the first virtual object, and then the first virtual object is not determined to be located in the first sensing range of the second virtual object. Those skilled in the art may specifically set the judgment criterion for the first sensing range according to the need to simulate the sensing ability of humans in the real world.

In an optional embodiment, the target second virtual object is invisible in the graphical user interface.

The indication control indicates the position and degree of alertness of the target second virtual object. In this embodiment, in order to simplify the graphical user interface, only the indication control of the second virtual object that is not visible in the graphical user interface and generates alertness to the first virtual object is displayed. As for the second virtual object that is visible in the graphical user interface, the player may directly judge its degree of alertness to the first virtual object according to the game screen.

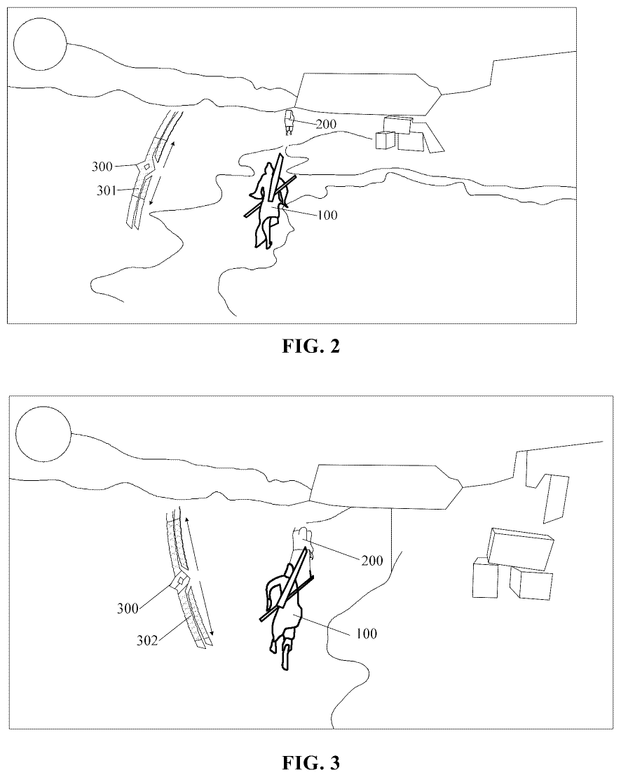

As shown in FIGS. 2 and 3, the graphical user interface includes a game scene, a first virtual object 100, a second virtual object 200, and an indication control 300. The indication control 300 further includes a quantification sub-control 301 (FIG. 2) and a quantification sub-control 302 (FIG. 3), which are used to quantitatively display the degree of alertness of the target second virtual object to the first virtual object. In FIG. 2, the indication control 300 is displayed with the first display parameter, and in FIG. 3, the indication control 300 is displayed with the second display parameter. From the appearance, quantification sub-controls differ in color. Different textures are used to represent different colors in the accompanying drawings. For example, the quantification sub-control 301 in FIG. 2 may be white, and the quantification sub-control 302 in FIG. 3 may be yellow. The indication controls in FIGS. 2 and 3 point to the target second virtual object that is not visible in the current graphical user interface, and the visible second virtual object 200 in the graphical user interface does not have a corresponding indication control. At the game moment shown in FIG. 2, the target second virtual object outside the screen has sensed the existence of the first virtual object 100, and the length of the progress bar of the quantification sub-control 301 shows the degree of alertness of the target second virtual object to the first virtual object 100. At the game moment shown in FIG. 3, the target second virtual object outside the screen has sensed the approximate position of the first virtual object 100 and started to move toward the first virtual object 100. The length of the progress bar of the quantification sub-control 301 shows the degree of alertness of the target second virtual object to the first virtual object 100. Obviously, the degree of alertness of the target second virtual object at this moment is higher than that of the game moment shown in FIG. 2.

As for the second virtual object 200 in FIGS. 2 and 3 having no corresponding indication controls, according to the game settings, it may be either because the second virtual object 200 is just a passerby, not an enemy of the first virtual object, and is not alert to the first virtual object; or it may be because the second virtual object 200 does not perceive the existence of the first virtual object 100, that is, the first virtual object 100 is not within the first sensing range of the second virtual object 200. Specifically, the second virtual object 200 may currently have its back to the first virtual object 100, so the first virtual object 100 is not within the visual field of the second virtual object 200, and the first virtual object 100 is in a process of stealthy movement, and making extremely weak sound, and thus is not within the auditory sensing range of the second virtual object 200.

In an optional embodiment, the position of the indication control on the graphical user interface includes one of the following: a perimeter of the graphical user interface; on a circle with the midpoint of the graphical user interface as the center; or on a circle surrounding the first virtual object.

As shown in FIG. 4, when there is a plurality of target second virtual objects, a plurality of indications controls 300 may be displayed on the graphical user interface. Three indication controls 300 are roughly located on a circle in the middle of the graphical user interface, thereby representing the relative positions of the three target virtual objects to the first virtual object 100. That is, the indication control 300 on the left indicates the target second virtual object located on the left side of the first virtual object, the indication control 300 on the right indicates the target second virtual object located on the right side of the first virtual object, and the indication control 300 at the bottom indicates the target second virtual object located behind the first virtual object.

In step S104, in response to the first virtual object being within the first sensing range and outside the second sensing range and the target second virtual object moving toward the first virtual object, the indication control is displayed on the graphical user interface with a second display parameter, and the position of the indication control on the graphical user interface is updated according to the relative position between the target second virtual object and the first virtual object.

In order to prompt the player of the different degrees of alertness of the target second virtual object to the first virtual object, so as to facilitate the player to make game decisions, the present disclosure displays the indication control with different display parameters. When the first virtual object enters the first sensing range of the target second virtual object and is outside the second sensing range, the target second virtual object may sense the existence of the first virtual object, but cannot determine its specific location. In this case, the target second virtual object has a relatively low degree of alertness to the first virtual object, and the indication control is displayed with the first display parameter. The relatively low degree of alertness may be represented by colors such as white, green, and blue, which are generally not used to indicate urgent situations, or may be represented by lighter colors, lower saturation, and higher transparency, or may be represented by a lower flashing frequency or even no flashing, or a smaller icon. Of course, different shapes may be used to represent different degrees of alertness. When the first virtual object is within the first sensing range and outside the second sensing range of the target second virtual object and the target second virtual object moves toward the first virtual object, in this case, although the target second virtual object has not yet determined the specific position of the first virtual object, it has already figured out the approximate position and starts to move toward the first virtual object. The degree of alertness for the first virtual object is relatively high, and the indication control is displayed with the second display parameter. A relatively high degree of alertness may be represented by yellow, orange, or other colors that indicate urgent situations, or represented by a darker color, higher saturation and lower transparency, or represented by a higher flashing frequency, or represented by a larger icon. Of course, a shape different from that of the first display parameter may be used to represent a higher alert level. When the first virtual object enters the second sensing range of the target second virtual object, the target second virtual object is already able to determine the specific position of the first virtual object, and the alert for the first virtual object is maximized. The indication control is displayed with the third display parameter. For example, the maximum degree of alertness is represented by a color indicating an emergency situation such as red, or represented by a darker color, higher saturation, and lower transparency than that of the second display parameter. It may also be represented by the highest flashing frequency or an icon that is larger than the that of second display parameter. Of course, the maximum degree of alertness may be represented by a shape that is different from those of the first display parameter and the second display parameter.

In an optional embodiment, the indication control includes a quantification sub-control, and the quantification sub-control is used to perform a quantitative display of a change in an alert value of the target second virtual object for the first virtual object, and the quantitative display of the quantification sub-control is updated according to the change in the alert value.

In order to provide players with more detailed information about the degrees of alertness (indicated by alert values), in addition to displaying the indication control with three different display parameters, the present disclosure further refines the display of the three different degrees of alertness through the quantitative sub-control on the indication control. In addition to being a progress bar, the quantification sub-control may also be a numerical change or a pie chart change; the display of progress bar may be in the form of increasing from one end to the other or from the middle to both ends, which can be set by those skilled in the art as needed.

In an optional embodiment, the alert value is related to at least one of: a distance between the first virtual object and the target second virtual object; a behavior of the first virtual object; an attribute of the first virtual object; an environment in which the first virtual object is located; an attribute of the target second virtual object; an environment in which the target second virtual object is located; a duration for which the first virtual object enters the first sensing range of the target second virtual object.

The closer the target second virtual object is to the first virtual object, the greater the degree of alertness. The louder the sound of the current behavior of the first virtual object, the greater the possibility of being perceived by the second virtual object. For example, sprinting is more likely to be perceived than walking or crawling. The stronger the attribute of the first virtual object to hide itself from being discovered, the lower the degree of alertness the target second virtual object to the first virtual object under the same circumstances. For example, game characters with ninja attributes, characters wearing protective color clothing, and characters with smaller bodies have stronger attributes to hide themselves from being discovered, and the target second virtual character has a lower degree of alertness to such game characters. The stronger the attributes such as alertness, sensing ability, physical strength, the greater the possibility of the second virtual character perceiving the first virtual object, and the greater the degree of alertness to the first virtual object. The environment in which the first virtual object and the target second virtual object are located may also affect the degree of alertness of the target second virtual object. For example, for the first virtual object, the degree of the alertness of the second virtual object is lower at night than during the day, and lower in a noisy environment than in a quiet environment.

In step S106, in response to the first virtual object entering the second sensing range, an indication control is displayed on the graphical user interface with a third display parameter, and the position of the indication control on the graphical user interface is updated according to the relative position between the target second virtual object and the first virtual object.

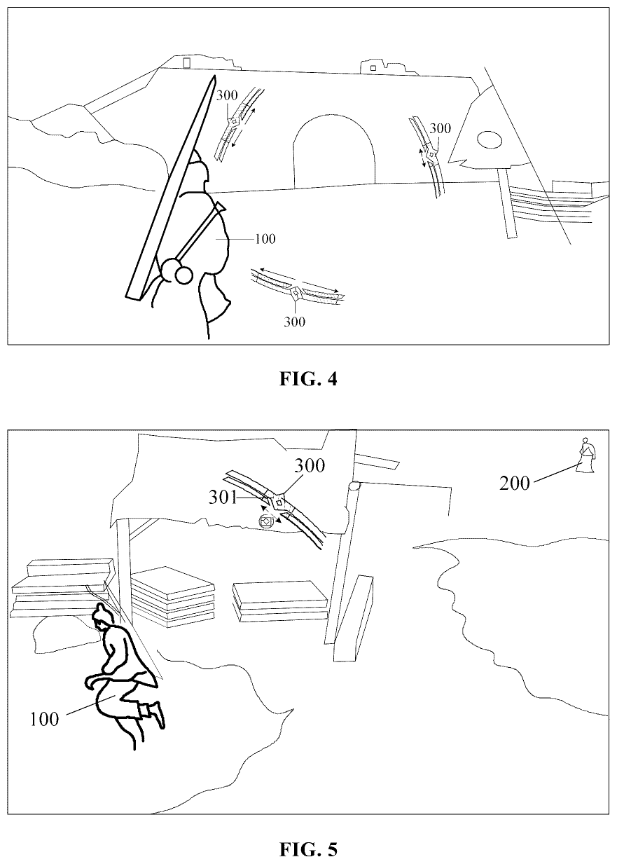

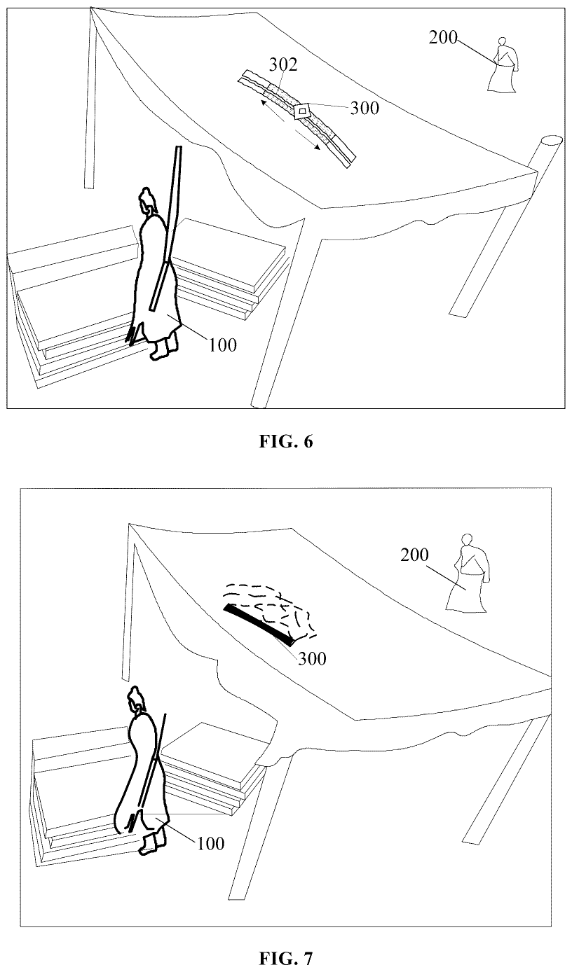

FIGS. 5-7 are used to exemplarily illustrate the change of the first virtual object 100 from being located in the first sensing range of the target second virtual object 200 to being located in the second sensing range of the target second virtual object. At the game moment shown in FIG. 5, the target second virtual object 200 is far away from the first virtual object 100, the existence of the first virtual object has been sensed, but the specific position thereof is not yet determined. At this moment, the first virtual object 100 is located within the first sensing range but outside the second sensing range of the target second virtual object 200, and the indication control 300 is displayed with the first display parameter (distinguished from the second display parameter through the color of the quantization sub-control 301, for example, it may be white), and points to the target second virtual object 200 (i.e., the upper right corner of the screen). At the game moment shown in FIG. 6, the target second virtual object 200 is close to the first virtual object 100. At this moment, the first virtual object 100 is still located within the first sensing range and outside the second sensing range of the target second virtual object 200, but begins to move towards the first virtual object 100, and the indication control 300 is displayed with the second display parameter (distinguished from the first display parameter through the color of the quantization sub-control 302, for example, it may be yellow), and points to the target second virtual object 200. At the game moment shown in FIG. 7, the target second virtual object 200 is one step closer to the first virtual object 100, and the specific position of the first virtual object 100 is determined. The first virtual object 100 is already within the visual range of the target second virtual object, and the distance is close enough, so that the target second virtual object can clearly distinguish the first virtual object 100, that is, the first virtual object 100 is within the second sensing range of the target second virtual object 200. At this moment, the indication control 300 is displayed with the third display parameter, and the color thereof is different from those of the first display parameter and the second display parameter, for example, it may be red and highlighted with special effects to remind the player that the first virtual object is discovered by the target second virtual object and the alert value is at the highest level.

In an optional embodiment, after the indication control is displayed on the graphical user interface with the third display parameter, a display of the indication control is cancelled after a preset duration.

When the first virtual object is within the second sensing range of the target second virtual object, the second virtual object is generally within the field of view of the first virtual object and occupies a larger proportion of the graphical user interface. In this case, the indication control displayed with the third display parameter basically completes its mission and does not need to remain in the graphical user interface. In order to reduce interference to the player, the indication control may no longer be displayed after a predetermined duration (such as one or two seconds). Of course, if there is more than one target virtual object, the corresponding other indicator controls that are not displayed with the third display parameter may continue to be displayed.

The information processing method of the present disclosure may be applied to scenarios such as mobile games, PC games, console games, and cloud games, etc.

In an exemplary embodiment of the present disclosure, an electronic device capable of implementing the above method is further provided.

Those skilled in the art may appreciate that various aspects of the present disclosure may be implemented as systems, methods or program products. Therefore, various aspects of the present disclosure may be specifically implemented in the following forms, namely: complete hardware implementation, complete software implementation (including firmware, microcode, etc.), or a combination of hardware and software, which may be collectively referred to herein as “circuits”, “modules” or “systems”.

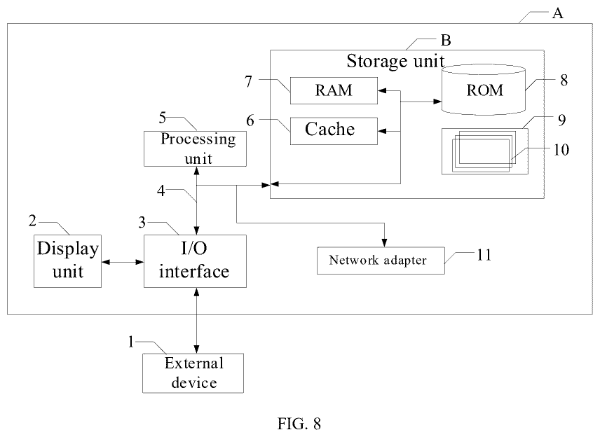

The electronic device A according to this embodiment of the present disclosure is described below with reference to FIG. 8. The electronic device A shown in FIG. 8 is merely an example and should not impose any limitation to the functions and scope of use of the embodiments of the present disclosure.

As shown in FIG. 8, the electronic device A is in the form of a general computing device. The components of the electronic device A may include but are not limited to: at least one processing unit 5, at least one storage unit B, a bus 4 connecting different system components (including the storage unit B and the processing unit 5), and a display unit 2.

The processing unit 5 displays a graphical user interface through a terminal device, where the graphical user interface includes at least a portion of a virtual scene, and a first virtual object and at least one second virtual object located in the virtual scene. The method may include the following steps:
in response to the first virtual object entering a first sensing range of a target second virtual object and being outside a second sensing range of the target second virtual object, displaying an indication control on the graphical user interface with a first display parameter, and updating a position of the indication control on the graphical user interface according to a relative position between the target second virtual object and the first virtual object, where the target second virtual object is one or more of the at least one second virtual object, and the second sensing range is smaller than the first sensing range;
in response to the first virtual object being located within the first sensing range and outside the second sensing range and the target second virtual object moving toward the first virtual object, displaying the indication control on the graphical user interface with a second display parameter, and updating the position of the indication control on the graphical user interface according to the relative position between the target second virtual object and the first virtual object; and
in response to the first virtual object entering the second sensing range, displaying the indication control on the graphical user interface with a third display parameter, and updating the position of the indication control on the graphical user interface according to the relative position between the target second virtual object and the first virtual object.

In this method, in response to the first virtual object entering two different sensing ranges of the target second virtual object and the actions taken by the target second virtual object, the indication control related to the position of the target virtual object is displayed with different display parameters. While providing the player with the position information of the target second virtual object, it can also reflect the alert status of the target second virtual object towards the first virtual object, so that the player can make more diverse game decisions. This can at least partially solve the technical problems existing in the related art solutions, such as the single type of information contained in the position prompt of the enemy character in the game, thereby improving the diversity of the types of information contained in the position prompt of the enemy character.

In some embodiments, the first virtual object entering the first sensing range of the target second virtual object may include:
sound emitted by the first virtual object propagating to the first sensing range.

In some embodiments, when the first virtual object is located within the first sensing range and outside the second sensing range, the target second virtual object is capable of perceiving a presence of the first virtual object but is unable to determine a specific position of the first virtual object.

In some embodiments, when the first virtual object is located in the second sensing range, the target second virtual object is capable of determining a specific position of the first virtual object.

In some embodiments, after the indication control is displayed on the graphical user interface with the third display parameter, a display of the indication control is canceled after a preset duration.

In some embodiments, the indication control includes a quantification sub-control, and the quantification sub-control is used to perform a quantitative display of a change in an alert value of the target second virtual object to the first virtual object, and updating the quantitative display of the quantification sub-control according to the change in the alert value.

In some embodiments, the alert value is related to at least one of the following:
a distance between the first virtual object and the target second virtual object;
a behavior of the first virtual object;
an attribute of the first virtual object;
an environment in which the first virtual object is located;
an attribute of the target second virtual object;
an environment in which the target second virtual object is located; and a duration for which the first virtual object enters the first sensing range of the target second virtual object.

In some embodiments, the position of the indication control on the graphical user interface includes one of following:
a perimeter of the graphical user interface;
on a circle centered at a midpoint of the graphical user interface; and
on a circle surrounding the first virtual object.

In some embodiments, the target second virtual object is not visible in the graphical user interface.

The storage unit B stores program codes, which can be executed by the processing unit 5, so that the processing unit 5 performs the steps according to various exemplary embodiments of the present disclosure described above in this specification. The storage unit B may include a readable medium in the form of a volatile storage unit, such as a random access memory unit (RAM) 7 and/or a cache memory unit 6, and may further include a read-only memory unit (ROM) 8.

The storage unit B may further include a program/utility 9 having a set (at least one) of program modules 10, such program modules 10 include but are not limited to: an operating system, one or more application programs, other program modules and program data, each of which or a combination thereof may include the implementation of a network environment.

Bus 4 may represent one or more of several types of bus architectures, including a memory unit bus or memory unit controller, a peripheral bus, a graphics acceleration port, a processing unit, or a local bus using any of a variety of bus architectures.

The electronic device A may also communicate with one or more external devices 1 (such as keyboards, pointing devices, Bluetooth devices, etc.), as well as with devices that enable users to interact with the electronic device A, and/or with any devices (such as routers, modems, etc.) that enable the electronic device A to communicate with one or more other computing devices. Such communication may be performed through the input/output (I/O) interface 3. Additionally, the electronic device A may communicate with one or more networks (such as a local area network (LAN), a wide area network (WAN), and/or a public network, such as the Internet) through the network adapter 11. As shown in the figure, the network adapter 11 communicates with other modules of the electronic device A via the bus 4. It should be understood that, although not shown in the figure, other hardware and/or software modules may be combined with the electronic device A, including but not limited to: microcode, device drivers, redundant processing units, external disk drive arrays, RAID systems, tape drives, and data backup storage systems, etc.

Through the description of the above embodiments, those skilled in the art can easily understand that the example embodiments described herein can be implemented by software, or can be implemented by a combination of software and necessary hardware. Therefore, the technical solution according to the embodiments of the present disclosure can be embodied in the form of a software product, which can be stored in a non-volatile storage medium (such as a CD-ROM, a USB flash drive, a mobile hard disk, etc.) or on a network, and includes several instructions to enable a computing device (such as a personal computer, a server, a terminal device, or a network device, etc.) to execute the method according to the embodiments of the present disclosure.

In an exemplary embodiment of the present disclosure, a computer-readable storage medium is further provided, on which a program product capable of implementing the above-mentioned information processing method of the present specification is stored. The method displays a graphical user interface through a terminal device, the graphical user interface includes at least a portion of a virtual scene, and a first virtual object and at least one second virtual object located in the virtual scene. The method may include the following steps:
in response to the first virtual object entering a first sensing range of a target second virtual object and being outside a second sensing range of the target second virtual object, displaying an indication control on the graphical user interface with a first display parameter, and updating a position of the indication control on the graphical user interface according to a relative position between the target second virtual object and the first virtual object, where the target second virtual object is one or more of the at least one second virtual object, and the second sensing range is smaller than the first sensing range;
in response to the first virtual object being located within the first sensing range and outside the second sensing range and the target second virtual object moving toward the first virtual object, displaying the indication control on the graphical user interface with a second display parameter, and updating the position of the indication control on the graphical user interface according to the relative position between the target second virtual object and the first virtual object; and
in response to the first virtual object entering the second sensing range, displaying the indication control on the graphical user interface with a third display parameter, and updating the position of the indication control on the graphical user interface according to the relative position between the target second virtual object and the first virtual object.

In this method, in response to the first virtual object entering two different sensing ranges of the target second virtual object and the actions taken by the virtual target second virtual object, the indication control related to the position of the target virtual object is displayed with different display parameters. While providing the player with the position information of the target second virtual object, it can also reflect the alert status of the target second virtual object towards the first virtual object, so that the player can make more diverse game decisions. This can at least partially solve the technical problems existing in the related art solutions, such as the single type of information contained in the position prompt of the enemy character in the game, thereby improving the diversity of the types of information contained in the position prompt of the enemy character.

In some embodiments, the first virtual object entering the first sensing range of the target second virtual object may include:
sound emitted by the first virtual object propagating to the first sensing range.

In some embodiments, when the first virtual object is located within the first sensing range and outside the second sensing range, the target second virtual object is capable of perceiving a presence of the first virtual object but is unable to determine a specific position of the first virtual object.

In some embodiments, when the first virtual object is located in the second sensing range, the target second virtual object is capable of determining a specific position of the first virtual object.

In some embodiments, after the indication control is displayed on the graphical user interface with the third display parameter, a display of the indication control is canceled after a preset duration.

In some embodiments, the indication control includes a quantification sub-control, and the quantification sub-control is used to perform a quantitative display of a change in an alert value of the target second virtual object to the first virtual object, and updating the quantitative display of the quantification sub-control according to the change in the alert value.

In some embodiments, the alert value is related to at least one of the following:
a distance between the first virtual object and the target second virtual object;
a behavior of the first virtual object;
an attribute of the first virtual object;
an environment in which the first virtual object is located;
an attribute of the target second virtual object;
an environment in which the target second virtual object is located; and
a duration for which the first virtual object enters the first sensing range of the target second virtual object.

In some embodiments, the position of the indication control on the graphical user interface includes one of following:
a perimeter of the graphical user interface;
on a circle centered at a midpoint of the graphical user interface; and
on a circle surrounding the first virtual object.

In some embodiments, the target second virtual object is not visible in the graphical user interface.

In some possible implementations, various aspects of the present disclosure can also be implemented in the form of a program product, which includes program code. When the program product runs on a terminal device, the program code is used to cause the terminal device to execute the steps according to various exemplary embodiments described in the foregoing specification of the present disclosure.

In the present disclosure, the indication control related to the position of the target virtual object is displayed with different display parameters in response to the first virtual object entering two different sensing ranges of the target second virtual object and the actions taken by the target second virtual object. While providing the player with the position information of the target second virtual object, it can also reflect the alert status of the target second virtual object towards the first virtual object, so that the player can make more diverse game decisions. This can at least partially solve the technical problems existing in the relevant technical solutions, such as the types of information contained in the position indication of the enemy character in the game being single, thereby improving the diversity of the types of information contained in the position prompt of the enemy character.

A program product for implementing the above method according to an embodiment of the present disclosure may employ a portable compact disc read-only memory (CD-ROM), include program code, and be capable of running on a terminal device such as a personal computer. However, the program product of the present disclosure is not limited thereto. In this document, a readable storage medium may be any tangible medium that contains or stores a program, which can be used by or in conjunction with an instruction execution system, apparatus, or device.

The program product may employ any combination of one or more readable media. The readable medium may be a readable signal medium or a readable storage medium. The readable storage medium may be, for example, but is not limited to, an electrical, magnetic, optical, electromagnetic, infrared, or semiconductor system, apparatus, or device, or any combination of the foregoing. More specific examples (a non-exhaustive list) of the readable storage medium include: an electrical connection having one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

A computer-readable signal medium may include a data signal propagated in a baseband or as part of a carrier wave, in which readable program code is carried. Such a propagated data signal may take various forms, including but not limited to an electromagnetic signal, an optical signal, or any suitable combination of the foregoing. The readable signal medium may also be any readable medium other than a readable storage medium, which can transmit, propagate, or transport a program for use by or in conjunction with an instruction execution system, apparatus, or device.

The program code contained on the readable medium can be transmitted by any suitable medium, including but not limited to wireless, wired, optical cable, RF, etc., or any suitable combination of the foregoing.

The program code for performing the operations of the present disclosure may be written in any combination of one or more programming languages, including object-oriented programming languages such as Java, C++, and conventional procedural programming languages such as the “C” language or similar programming languages. The program code may be executed entirely on the user computing device, partially on the user device, as a stand-alone software package, partially on the user computing device and partially on a remote computing device, or entirely on a remote computing device or server. In the cases that a remote computing device is involved, the remote computing device may be connected to the user computing device through any type of network, including a local area network (LAN) or a wide area network (WAN), or may be connected to an external computing device (e.g., via the Internet provided by an Internet service provider).

In addition, the above-mentioned accompanying drawings are only schematic illustrations of the processes included in the method according to the exemplary embodiments of the present disclosure, and are not intended to be limiting. It is easy to understand that the processes shown in the above-mentioned drawings do not indicate or limit the time sequence of these processes. In addition, it is also easy to understand that these processes can be performed synchronously or asynchronously, for example, in multiple modules.

It should be noted that, although several modules or units of the device for action execution are mentioned in the above detailed description, such division is not mandatory. In fact, according to the embodiments of the present disclosure, the features and functions of two or more modules or units described above can be embodied in one module or unit. On the contrary, the features and functions of one module or unit described above can be further divided to be embodied by a plurality of modules or units.

Other embodiments of the present disclosure will be readily conceived by those skilled in the art upon consideration of the specification and practice of the invention disclosed herein. The present disclosure is intended to cover any variations, uses, or adaptations of the present disclosure that follow the general principles of the present disclosure and include common general knowledge or conventional technical means in the art that are not disclosed herein. The specification and examples are to be regarded as exemplary only, and the true scope and spirit of the present disclosure are indicated by the claims.

It should be understood that the present disclosure is not limited to the precise structures described above and shown in the drawings, and various modifications and changes can be made without departing from the scope thereof. The scope of the present disclosure is limited only by the appended claims.

1. An information processing method, wherein a graphical user interface is displayed by a terminal device, and the graphical user interface comprises at least a portion of a virtual scene, and a first virtual object and at least one second virtual object located in the virtual scene, wherein the method comprises:
in response to the first virtual object entering a first sensing range of a target second virtual object and being located outside a second sensing range of the target second virtual object, displaying an indication control on the graphical user interface with a first display parameter, and updating a position of the indication control on the graphical user interface according to a relative position between the target second virtual object and the first virtual object, wherein the target second virtual object is one or more of the at least one second virtual object, and the second sensing range is smaller than the first sensing range;
in response to the first virtual object being located within the first sensing range and outside the second sensing range and the target second virtual object moving toward the first virtual object, displaying the indication control on the graphical user interface with a second display parameter, and updating the position of the indication control on the graphical user interface according to the relative position between the target second virtual object and the first virtual object; and
in response to the first virtual object entering the second sensing range, displaying the indication control on the graphical user interface with a third display parameter, and updating the position of the indication control on the graphical user interface according to the relative position between the target second virtual object and the first virtual object.

2. The method according to claim 1, wherein the first virtual object entering the first sensing range of the target second virtual object comprises:
sound emitted by the first virtual object propagating to the first sensing range.

3. The method according to claim 1, wherein in a case that the first virtual object is located within the first sensing range and outside the second sensing range, the target second virtual object is capable of perceiving a presence of the first virtual object but is unable to determine a specific position of the first virtual object.

4. The method according to claim 1, wherein in a case that the first virtual object is located in the second sensing range, the target second virtual object is capable of determining a specific position of the first virtual object.

5. The method according to claim 1, wherein after displaying the indication control on the graphical user interface with the third display parameter, a display of the indication control is canceled after a preset duration.

6. The method according to claim 1, wherein the indication control comprises a quantification sub-control, and the quantification sub-control is used to perform a quantitative display of a change in an alert value of the target second virtual object with respect to the first virtual object, and the quantitative display of the quantification sub-control is updated according to the change in the alert value.

7. The method according to claim 6, wherein the alert value is related to at least one of following:
a distance between the first virtual object and the target second virtual object;
a behavior of the first virtual object;
an attribute of the first virtual object;
an environment in which the first virtual object is located;
an attribute of the target second virtual object;
an environment in which the target second virtual object is located; or
a duration for which the first virtual object enters the first sensing range of the target second virtual object.

8. The method according to claim 1, wherein the position of the indication control on the graphical user interface comprises one of following:
a perimeter of the graphical user interface;
on a circle centered at a midpoint of the graphical user interface; and
on a circle surrounding the first virtual object.

9. The method of claim 1, wherein the target second virtual object is invisible in the graphical user interface.

10. An electronic device, comprising:
a processor; and
a memory, configured to store executable instructions of the processor;
wherein a graphical user interface is displayed by a terminal device, and the graphical user interface comprises at least a portion of a virtual scene, and a first virtual object and at least one second virtual object located in the virtual scene, and the processor is configured to:
in response to the first virtual object entering a first sensing range of a target second virtual object and being located outside a second sensing range of the target second virtual object. display an indication control on the graphical user interface with a first display parameter, and update a position of the indication control on the graphical user interface according to a relative position between the target second virtual object and the first virtual object, wherein the target second virtual object is one or more of the at least one second virtual object, and the second sensing range is smaller than the first sensing range:
in response to the first virtual object being located within the first sensing range and outside the second sensing range and the target second virtual object moving toward the first virtual object, display the indication control on the graphical user interface with a second display parameter, and update the position of the indication control on the graphical user interface according to the relative position between the target second virtual object and the first virtual object; and
in response to the first virtual object entering the second sensing range, display the indication control on the graphical user interface with a third display parameter, and update the position of the indication control on the graphical user interface according to the relative position between the target second virtual object and the first virtual object.

11. A non-transitory computer-readable storage medium, wherein the computer-readable storage medium stores a computer program, wherein a graphical user interface is displayed by a terminal device, and the graphical user interface comprises at least a portion of a virtual scene, and a first virtual object and at least one second virtual object located in the virtual scene, and the computer program, when executed by a processor, implements following steps:
in response to the first virtual object entering a first sensing range of a target second virtual object and being located outside a second sensing range of the target second virtual object, displaying an indication control on the graphical user interface with a first display parameter, and updating a position of the indication control on the graphical user interface according to a relative position between the target second virtual object and the first virtual object, wherein the target second virtual object is one or more of the at least one second virtual object, and the second sensing range is smaller than the first sensing range:
in response to the first virtual object being located within the first sensing range and outside the second sensing range and the target second virtual object moving toward the first virtual object, displaying the indication control on the graphical user interface with a second display parameter, and updating the position of the indication control on the graphical user interface according to the relative position between the target second virtual object and the first virtual object; and
in response to the first virtual object entering the second sensing range, displaying the indication control on the graphical user interface with a third display parameter, and updating the position of the indication control on the graphical user interface according to the relative position between the target second virtual object and the first virtual object.

12. The method according to claim 1, wherein in a case that a trigger condition for displaying the indication control is met, a corresponding second virtual object is the target second virtual object.

13. The method according to claim 12, wherein the method further comprises:
in a case that a plurality of second virtual objects that meet the trigger condition for displaying the indication control exist, displaying a plurality of indication controls on the graphical user interface.

14. The method according to claim 1, wherein each of the first sensing range and the second sensing range comprises at least one of a visual sensing range or an auditory sensing range.

15. The method according to claim 6, wherein the quantification sub-control is at least one of a progress bar, a numerical change or a pie chart change.

16. The electronic device according to claim 10, wherein the first virtual object entering the first sensing range of the target second virtual object comprises: sound emitted by the first virtual object propagating to the first sensing range.

17. The electronic device according to claim 10, wherein in a case that the first virtual object is located within the first sensing range and outside the second sensing range, the target second virtual object is capable of perceiving a presence of the first virtual object but is unable to determine a specific position of the first virtual object.

18. The electronic device according to claim 10, wherein in a case that the first virtual object is located in the second sensing range, the target second virtual object is capable of determining a specific position of the first virtual object.

19. The electronic device according to claim 10, wherein after displaying the indication control on the graphical user interface with the third display parameter, a display of the indication control is canceled after a preset duration.

20. The electronic device according to claim 10, wherein the indication control comprises a quantification sub-control, and the quantification sub-control is used to perform a quantitative display of a change in an alert value of the target second virtual object with respect to the first virtual object, and the quantitative display of the quantification sub-control is updated according to the change in the alert value.
